(19) United States
(12) Patent Application Publication
(10) Pub. No.: US 2009/0155505 A1
(43) Pub. Date: Jun. 18, 2009

(54) Packaging unit having a fragrance carrier

(76) Inventor: Les Wagenheim, Pepper Pike, OH (US)

Correspondence Address: ROETZEL AND ANDRESS, 222 SOUTH MAIN STREET, AKRON, OH, 44308, US

(21) Appl. No.: 12/070,802

(22) Filed: Feb. 21, 2008

Related U.S. Application Data
(60) Provisional application No. 61/007,465, filed on Dec. 13, 2007.

(51) Int. Cl. B32B 1/06

(52) U.S. Cl. 428/34.2; 428/34.1; 428/35.7

(57) ABSTRACT

Various embodiments of a packaging unit are provided. In one embodiment the present invention provides for a packaging unit with an outer shell and an inner sealed container of fragrance material disposed within the outer shell. The packaging unit also includes a carrier comprising a fragrance material disposed between the inner sealed container and the outer shell, and the fragrance material of the carrier has an aroma which is substantially similar or identical to the fragrance material of the inner sealed container. A consumer is able to sense the aroma of the fragrance material of the carrier which permeates through the outer shell in order to know the aroma of the fragrance material inside the inner sealed container.

### RELATED APPLICATION DATA

This application claims priority to previously filed U.S. Provisional Patent Application No. 61/007,465, filed on Dec. 13, 2007, entitled “Packaging Unit Having a Fragrance Carrier,” which is incorporated herein by reference in its entirety.

### FIELD OF THE INVENTION

The present invention relates to the general field of packaging and, more specifically, to packaging that has a fragrance release feature and a method for providing a fragrance release feature in the package.

### BACKGROUND OF THE INVENTION

Products having a fragrance for air freshening, for example, are often contained in sealed packaging so that the material does not diffuse into the air prior to purchase. However, with such packaging it is often difficult or impossible to determine the scent or fragrance of material within a sealed package. One method is to place a sample of the scented material onto a substrate, for example, paper card, stock or cloth. Such scented material can be in the form of a “scratch and sniff” patch. In such an example, microcapsules are ruptured and release a fragrance. One problem with this method is that the fragrance eventually dissipates over a short period of time and one is then unable to smell the scented material to identify the fragrance of the product being sold in the packaging.

### SUMMARY OF THE INVENTION

The present invention provides for a packaging unit which includes an inner sealed container comprising a fragrance material, and an outer shell which houses the inner sealed container. The packaging unit also includes a carrier comprising a fragrance material which has an aroma/scent which is substantially similar to the aroma/scent of the fragrance material inside the sealed container. The aroma of the fragrance material of the carrier permeates through crevices or air passages of the outer shell and the consumer can sense the fragrance material which is at least substantially the same as the fragrance material inside the sealed container.

In one embodiment the present invention discloses packaging unit comprising an outer shell, an inner sealed container disposed within the outer shell and containing a first fragrance material, and a carrier having a second fragrance material disposed between the inner sealed container and the outer shell, the second fragrance material having an aroma similar to or identical to the aroma of the first fragrance material.

In another embodiment the present invention discloses a packaging unit comprising an outer shell with one or more slot openings, an inner sealed container disposed within the outer shell and containing a first fragrance material, and a carrier having a second fragrance material disposed between the inner sealed container and the outer shell, the second fragrance material of the carrier has having an aroma similar to or identical to the aroma of the first fragrance material.

### DESCRIPTION OF THE DRAWINGS

The various embodiments of the present invention can be understood by the following drawings and figures. The components are not necessarily to scale.

FIG. 1 is a perspective view of the packaging unit, which includes an inner sealed container and an outer shell, according to an embodiment of the present invention;

FIG. 2 is a perspective view of the packaging unit of FIG. 1, showing the outer shell opened to reveal the carrier comprising of fragrance substance disposed between the inner sealed container and the outer shell, according to an embodiment of the present invention; and

FIG. 3 is an exploded view of the packaging unit illustrating the inner sealed container, the carrier comprising of fragrance substance, and inserts placed within the outer shell, according to an embodiment of the present invention.

### DETAILED DESCRIPTION OF THE INVENTION

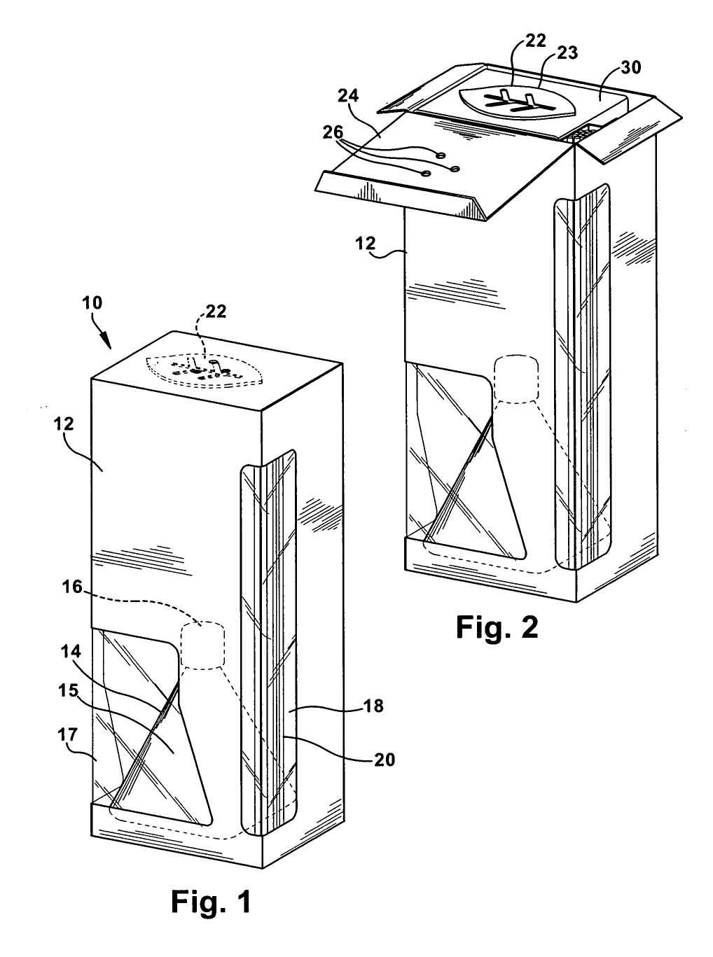

FIG. 1 provides a perspective view of packaging unit 10 according to one embodiment of the present invention. Packaging unit 10 includes outer shell 12 and inner sealed container 14 having a base portion 15 containing a liquid having a fragrance, and a cap portion 16 which seals container 14. Outer shell 12 may include an optional window 17 revealing sealed container 14, and outer shell 12 may also optionally includes second window 18 revealing additional components such as, for example, one or more wicking sticks 20 used in conjunction with sealed container 14. Packaging unit 10 also includes carrier 22 comprising a fragrance substance and is disposed between sealed container 14 and outer shell 12 of the packaging unit.

FIG. 2 is a perspective view of packaging unit 10 illustrating carrier 22 comprising of fragrance shown with outer shell 12 opened. In one embodiment of the invention, outer shell 12 can be opened at the top with a top flap portion 24. Top flap portion 24 can optionally include a plurality and/or a variety of slot openings 26.

Carrier 22 comprising fragrance substance is disposed proximate the plurality of slot openings 26 on the surface of outer shell 12 so that when outer shell 12 is closed the fragrance material can be sensed by someone located near the package. The fragrance material of carrier 22 is substantially similar or identical to the fragrance material contained within sealed container 14.

The material used to form carrier 22 includes, but is not limited to, polymers, polymer films, paper, cardboard, craft paper, extrudable plastics and/or any combination thereof. Examples of polymers include, but are not limited to, polyethylene, polypropylene, ethylene vinyl acetate, polystyrene, nylon, polyester, and polyvinyl chloride. In one embodiment carrier 22 is saturated, or supersaturated, with, for example, a fragrance material in the form of a perfume or scented oils. The fragrance material contained in carrier 22 then volatilizes, irradiates, and/or blooms from the surfaces of carrier 22 over time, thereby providing aroma to the exterior surfaces of the packaging. Bloom is a term of art in the plastics industry which defines the migration of a liquid or solid material from the composition of the plastic to the surface of the plastic. Bloom can be triggered when a dissolved ingredient is added to the plastic compound in a concentration in excess of its solubility. In such a situation, the conditions for crystallization of the supersaturated ingredient are more favorable in the presence of the air than within the body of the plastic compound. The supersaturated ingredient then separates out of the plastic compound and crystallizes at the surface of the plastic as it contacts the surrounding air.

In one embodiment, carrier 22 can include a plurality of slots 23 which provide for increased surface area of carrier 22. Carrier 22 is shown in the attached Figures as a football shaped flat object, however, carrier 22 is not limited to just the design orientation depicted in the attached Figures. Rather, carrier 22 can be formed in any designed shape. Such shapes include, but are not limited to, a square, a rectangular, a sphere, a triangle, or a circular disc. In another embodiment, any two or three-dimensional shapes can be used for carrier 22. As shown in the embodiment, packaging unit 10 further may include an insert 30 which supports carrier 22 near the surface of outer shell 24 and proximate to the plurality of openings 26 of outer shell 12.

Fragrances selected for use in the packaging unit in accordance with an embodiment of the present invention contain ingredients which provide a fresh impression in the area or on the surface to which the composition is directed. For example, the fragrance material of sealed container 14 and/or carrier 22 can include, but is not limited to, aromatic and aliphatic esters, aliphatic and aromatic alcohols, aromatic and aliphatic ketones, aromatic and aliphatic lactones, aromatic and aliphatic aldehydes, aromatic aldehydes, aliphatic and aromatic ethers, condensation products of aldehydes and amines, or mixtures of two or more thereof.

In another embodiment of the present invention the fragrance can be an essential oil. Essential oils can include, but are not limited to, those obtained from thyme, lemongrass, citrus, lemons, oranges, anise, clove, aniseed, geranium, roses, mint, lavender, citronella, eucalyptus, peppermint, camphor, sandalwood, pine, vervain, rosmarin, fleagrass, ratanhiae and cedar, or mixtures of two or more thereof. Actives of essential oils for use herein include, but are not limited to, thymol (present for example in thyme), eugenol (present for example in clove), menthol (present for example in mint), geraniol (present for example in geranium and rose), verbenone (present for example in vervain), eucalyptol and pinocarvone (present in eucalyptus), cedrol (present for example in cedar), anethol (present for example in anise), carvacrol, hinokitiol, berberine, ferulic acid, methyl salicylic acid, methyl salicylate, terpineol, or mixtures of two or more thereof.

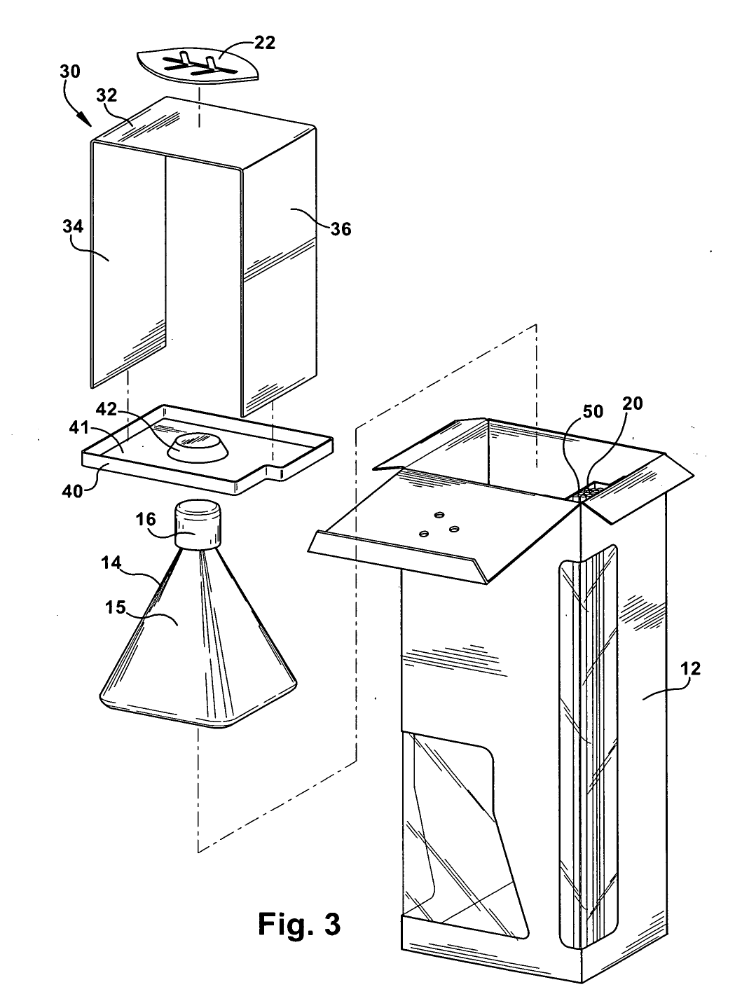

FIG. 3 is an exploded view of the packaging unit shown in FIGS. 1 and 2. FIG. 3 shows optional insert 30, which supports carrier 22. Insert 30 includes top surface 32 and side walls 34 and 36, which prop against the inside of outer shell 12 to support the carrier near the top portion of the packaging unit. FIG. 3 also shows a second optional insert 40, which is disposed between sealed container 14 and the insert 30. Insert 40 has a top surface 41 onto which the side walls 34 and 36 of insert 30 can optionally rest. Insert 40 also includes a molded raised portion 42 which conforms to the geometry shape of cap portion 16 of sealed container 14 to secure sealed container 14 during shipment.

FIG. 3 also reveals the top portion of compartment 50 which contains the one or more wicking sticks 20 (see FIG. 1). Wicking sticks 20 are placed within sealed container 14 after the cap is opened. Sticks 20 can be placed into the body of sealed container 14 containing a fragrance and then removed and flipped over to expose the sticks to the air, thereby providing fragrance to the room.

While embodiments of the invention have been described, it will be understood by those skilled in the art that various changes may be made and equivalents may be substituted for unit thereof without departing from the scope of the invention. For example, although embodiments discussed above pertain to a rectangular outer shell, it should be understood that several other types of geometries can be used for the outer shell as well as the inner sealed container. In addition, modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A packaging unit comprising:
an outer shell;
an inner sealed container disposed within the outer shell and containing a first fragrance material; and
a carrier having a second fragrance material disposed between the inner sealed container and the outer shell, the second fragrance material having an aroma similar to, or identical to, the aroma of the first fragrance material.

2. The packaging unit of claim 1, wherein the outer shell includes openings proximate to the carrier.

3. The packaging unit of claim 1, further comprising an insert located inside the outer shell supporting the carrier.

4. The packaging unit of claim 3, wherein the insert has a top surface and two sidewalls contacting the outer shell and supporting the insert with the carrier proximate to the surface of the outer shell.

5. The packaging unit of claim 1, wherein the outer shell includes a window for viewing the inner sealed container.

6. The packaging unit of claim 1, wherein the carrier includes openings which expose interior portions of the carrier to the air.

7. The packaging unit of claim 1, wherein the carrier is a polymer, polymer film, paper, cardboard, craft paper, extrudable plastic, or any combination thereof.

8. The packaging unit of claim 1, wherein the carrier is polyethylene, polypropylene, ethylene vinyl acetate, polystyrene, nylon, polyester, polyvinyl chloride, or any combination thereof.

9. The packaging unit of claim 1, wherein the fragrance material is an essential oil selected from thyme, lemongrass, citrus, lemons, oranges, anise, clove, aniseed, geranium, roses, mint, lavender, citronella, eucalyptus, peppermint, camphor, sandalwood, pine, vervain, rosmarin, fleagrass, ratanhiae, cedar, or any combinations thereof.

10. The packaging unit of claim 1, further comprising grass sticks disposed inside the outer shell.

11. A packaging unit comprising:
an outer shell with one or more slot openings;
an inner sealed container disposed within the outer shell and containing a first fragrance material; and
a carrier having a second fragrance material disposed between the inner sealed container and the outer shell, the second fragrance material of the carrier has having an aroma similar to, or identical to, the aroma of the first fragrance material.

12. The packaging unit of claim 11, wherein the carrier is proximate to the one or more slot openings.

13. The packaging unit of claim 12, further comprising an insert located inside the outer shell supporting the carrier adjacent to the one or more slot openings.

14. The packaging unit of claim 11, wherein the outer shell includes a window for viewing the inner sealed container disposed inside the outer shell.

15. The packaging unit of claim 11, wherein the carrier is a polymer, polymer film, paper, cardboard, craft paper, extrudable plastic, or any combination thereof.

16. The packaging unit of claim 11, wherein the carrier is polyethylene, polypropylene, ethylene vinyl acetate, polystyrene, nylon, polyester, polyvinyl chloride, or any combination thereof.

17. The packaging unit of claim 11, wherein the fragrance material is an essential oil selected from thyme, lemongrass, citrus, lemons, oranges, anise, clove, aniseed, geranium, roses, mint, lavender, citronella, eucalyptus, peppermint, camphor, sandalwood, pine, vervain, rosmarin, fleagrass, ratanhiae, cedar, or any combinations thereof.

18. The packaging unit of claim 11, further comprising grass sticks disposed inside the outer shell.
